(19) United States
(12) Patent Application Publication
(10) Pub. No.: US 2026/0289324 A1
(43) Pub. Date: Sep. 24, 2026

(54) DISTRIBUTED TRAINING METHOD FOR MULTIMODAL LARGE MODEL, DEVICE, AND MEDIUM

(71) Applicant: Beijing Baidu Netcom Science Technology Co., Ltd., Beijing (CN)

(72) Inventors: Dianhai YU, Beijing (CN); Guoxia WANG, Beijing (CN); Nian WANG, Beijing (CN); Jinle ZENG, Beijing (CN); Haifeng WANG, Beijing (CN)

(21) Appl. No.: 19/689,129

(22) Filed: May 27, 2026

(30) Foreign Application Priority Data
Jun. 30, 2025 (CN) 202510897133.1

(51) Int. Cl. G06N 3/098

(52) U.S. Cl. CPC G06N 3/098

(57) ABSTRACT

A distributed training method for a multimodal large model, a device, and a medium are provided, which relate to artificial intelligence and big data technology, and in particular to technical fields such as computer vision, deep learning, and large models. The method includes: partitioning, by using devices loaded with a large model to be trained, token sequences of sample data of training data subsets respectively input into the devices, to obtain token subsequences of the sample data for each training data subset, where a difference between total numbers of tokens of the sample data contained in different training data subsets is less than a predetermined threshold; and training the large model to be trained loaded on the devices based on the token subsequences of the sample data for each training data subset, to obtain a target multimodal large model, where each device is input with one training data subset.

### CROSS-REFERENCE TO RELATED APPLICATION

This application claims the benefit of Chinese Patent Application No. 202510897133.1 filed on Jun. 30, 2025, the whole disclosure of which is incorporated herein by reference.

### TECHNICAL FIELD

The present disclosure relates to the field of artificial intelligence technology and big data technology, and in particular to technical fields such as computer vision, deep learning, and large models, and may be applied to multimodal task scenarios such as text processing, image processing, audio processing, and video processing. More specifically, the present disclosure provides a distributed training method for a multimodal large model, a task processing method, a device, and a medium.

### BACKGROUND

With the development of artificial intelligence technology and big data technology, data and information in the real world are not of a single modality. For example, a video contains images and audio, and a social media post may contain text and images. Large-scale multimodal large language models (MLLMs) are a class of models that combine the natural language processing capability of large language models (LLMs) with the capability of understanding and generating data of other modalities (such as vision, audio, etc.), enabling better understanding and processing of such multimodal data and information. Distributed training of MLLMs faces multiple severe challenges, including issues such as low resource utilization, high communication overhead, and low overall training efficiency.

### SUMMARY

The present disclosure provides a distributed training method for a multimodal large model, a task processing method, a device, and a medium.

According to an aspect of the present disclosure, a distributed training method for a multimodal large model is provided, including: partitioning, by using a plurality of devices loaded with a large model to be trained, token sequences of sample data of a plurality of training data subsets respectively input into the plurality of devices, to obtain a plurality of token subsequences of the sample data for each of the plurality of training data subsets, where a difference between total numbers of tokens of the sample data contained in different training data subsets is less than a predetermined threshold; and training the large model to be trained loaded on the plurality of devices based on the plurality of token subsequences of the sample data for each of the plurality of training data subsets, to obtain a target multimodal large model, where each device is input with one training data subset.

According to another aspect of the present disclosure, a task processing method is provided, including: inputting data to be processed into a target multimodal large model for processing, to output a task processing result, where the target multimodal large model is trained based on the training method or training apparatus of the present disclosure.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to perform the methods provided in the present disclosure.

According to another aspect of the present disclosure, a non-transitory computer-readable storage medium having computer instructions therein is provided, where the computer instructions are configured to cause a computer to perform the methods provided in the present disclosure.

It should be understood that the content described in this section is not intended to identify key or essential features of embodiments of the present disclosure, nor is it intended to limit the scope of the present disclosure. Other features of the present disclosure will become easily understood through the following description.

### BRIEF DESCRIPTION OF THE DRAWINGS

The accompanying drawings are provided for better understanding of the solution and do not constitute a limitation to the present disclosure. In the accompanying drawings:

FIG. 1 shows a schematic diagram of an exemplary system architecture to which a distributed training method and apparatus for a multimodal large model and a task processing method and apparatus may be applied according to an embodiment of the present disclosure;

FIG. 2 shows a flowchart of a distributed training method for a multimodal large model according to an embodiment of the present disclosure;

FIG. 3 shows a schematic diagram of a distributed parallel training strategy arrangement according to an embodiment of the present disclosure;

FIG. 4 shows a layout diagram of a plurality of attention heads according to an embodiment of the present disclosure;

FIG. 5 shows a schematic diagram of determining training data subsets based on tokens according to an embodiment of the present disclosure;

FIG. 6 shows a flowchart of a distributed training method for a multimodal large model according to another embodiment of the present disclosure;

FIG. 7 shows a schematic diagram of partition switching between a sequence dimension and a head dimension according to an embodiment of the present disclosure;

FIG. 8 shows a flowchart of a task processing method according to an embodiment of the present disclosure;

FIG. 9 shows a block diagram of a distributed training apparatus for a multimodal large model according to an embodiment of the present disclosure;

FIG. 10 shows a block diagram of a task processing apparatus according to an embodiment of the present disclosure; and

FIG. 11 shows a schematic block diagram of an example electronic device 1100 that may be used to implement embodiments of the present disclosure.

### DETAILED DESCRIPTION OF EMBODIMENTS

Exemplary embodiments of the present disclosure are described below with reference to the accompanying drawings, which include various details of embodiments of the present disclosure to facilitate understanding, and which should be regarded as illustrative only. Accordingly, those of ordinary skill in the art will recognize that various changes and modifications may be made to embodiments described herein without departing from the scope and spirit of the present disclosure. Likewise, for clarity and conciseness, descriptions of well-known functions and structures are omitted in the following description.

Distributed training of MLLMs faces multiple challenges, which mainly arise from the inherent heterogeneity of data and the complexity of model architectures. These factors collectively lead to low utilization of computational resources, massive communication overhead, and a significant reduction in overall training efficiency. The heterogeneity of data is mainly reflected in an input sequence length of training datasets, limitations in resolution, differences in computation, and so on.

The input sequence length is reflected in that: real-world datasets (especially multimodal data integrating text, images, and videos) exhibit high variability in input sequence lengths, image resolutions, and video durations. However, conventional deep learning frameworks typically require fixed-length inputs, which forces padding of shorter sequences. Such padding operations lead to a waste of computation on useless tokens and result in underutilization of GPU memory, and the problem becomes more prominent when micro-batch sizes are limited by the longest sequence in the batch.

The limitations in resolution are reflected in that: Vision Transformer (ViT) models typically experience performance degradation when processing images of different resolutions during task processing and training. Although research has attempted to make such models adaptable to variable resolutions, this is often accompanied by additional computational costs or performance compromises, thereby limiting their widespread application in diversified vision tasks. Due to the continuously variable duration, video data further exacerbates data imbalance issue, making efficiency bottlenecks in the training process more significant than those encountered with static images or text data.

The differences in computation are reflected in computational differences between the ViT Tokenizer and the Mixture-of-Experts (MoE) backbone network. Image and video data are processed through a unified ViT Tokenizer, which has a lightweight parameter scale. The backbone network may employ a large-scale, highly sparsely activated MoE architecture, where the MoE model increases model capacity and reduces the computational cost per token by activating only a portion of experts. However, such an architecture also introduces challenges, such as imbalanced token routing and significant communication overhead, resulting in tail latency and low processing efficiency. The significant differences in computational characteristics and parameter scales between the ViT Tokenizer and the MoE backbone network make it difficult for a single distributed parallel strategy to adapt efficiently. Existing methods typically employ a spatio-temporal multiplexing distributed parallel strategy; however, such methods may fail to fully address efficiency bottlenecks because the heterogeneity between model submodules may lead to differences in computational requirements, which may result in sub-optimal performance if not considered.

In large-scale deep learning model training, handling heterogeneous data and variable input lengths is a key challenge for improving efficiency. Input sequence lengths in real-world datasets usually exhibit a skewed distribution. For example, in some datasets, short sequences account for the majority of samples, while long sequences contribute the majority of tokens. Training with mixed long and short sequences is beneficial for model performance, but traditional static parallel strategies struggle to handle such cases effectively, resulting in low utilization of computational resources, redundant communication, and load imbalance. To avoid out-of-memory errors, a context parallel (CP) group may be configured to support a size of the longest sequence, but this leads to significant resource idling when processing short sequences. In addition, ViT performance degrades when processing images of different resolutions, which limits its application in diversified vision tasks.

To overcome the above technical problems, several load balancing mechanisms have been proposed successively. However, these load balancing mechanisms are static or coarse-grained, making it difficult to respond in real-time and in a fine-grained manner to the imbalance in computational load, memory usage, and communication cost caused by continuously variable resolutions and durations of multimodal data (especially images and videos). For example, although dynamic batching may adjust batch sizes, it may fail to address efficiency issues caused by different sequence lengths within a batch.

In view of the above, embodiments of the present disclosure provide a distributed training method and apparatus for a multimodal large model, a device, and a medium. The training method includes: partitioning, by using a plurality of devices loaded with a large model to be trained, token sequences of sample data of a plurality of training data subsets respectively input into the plurality of devices, to obtain a plurality of token subsequences of the sample data for each of the plurality of training data subsets, where a difference between total numbers of tokens of the sample data contained in different training data subsets is less than a predetermined threshold; and training the large model to be trained loaded on the plurality of devices based on the plurality of token subsequences of the sample data for each of the plurality of training data subsets, to obtain a target multimodal large model, where each device is input with one training data subset. The training method is a hierarchical coarse-to-fine-grained multimodal data balancing strategy, which may alleviate issues such as imbalance in computational load, memory usage, and communication cost caused by variable resolutions, duration differences, and the like.

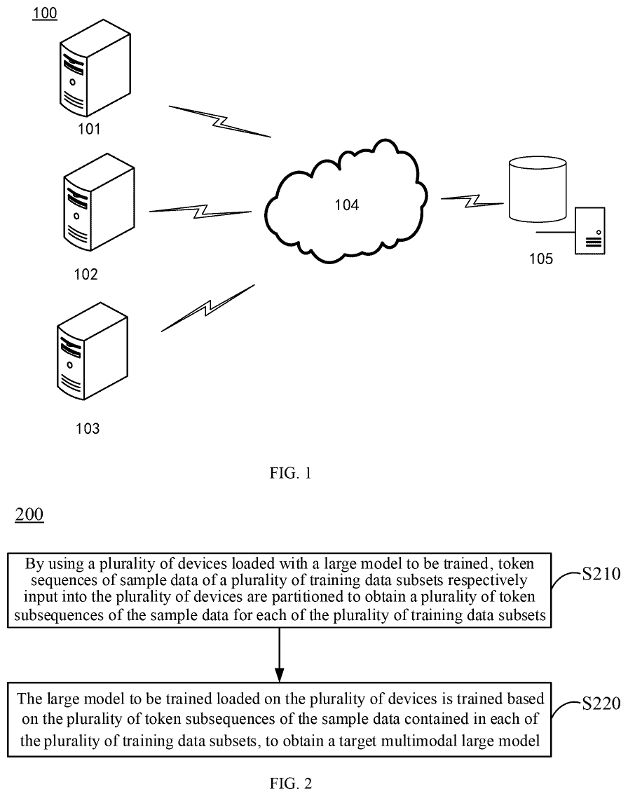

FIG. 1 shows a schematic diagram of an exemplary system architecture to which a distributed training method and apparatus for a multimodal large model and a task processing method and apparatus may be applied according to an embodiment of the present disclosure. It should be noted that FIG. 1 is merely an example of a system architecture to which embodiments of the present disclosure may be applied, so as to help those skilled in the art understand the technical content of the present disclosure, and does not mean that embodiments of the present disclosure cannot be applied to other devices, systems, environments, or scenarios.

As shown in FIG. 1, a system architecture 100 according to such embodiments may include servers 101, 102, 103, a network 104, and a database 105. The network 104 serves as a medium for providing a communication link between the servers 101, 102, 103 and the database 105. The network 104 may include various connection types, such as wired and/or wireless communication links, and so on.

The servers 101, 102, 103 may be servers integrated with a central processing unit (CPU), a graphics processing unit (GPU), and/or a tensor processing unit (TPU). The servers 101, 102, 103 provide computational resources and storage resources for the large model to be trained.

The database 105 may store a training dataset including multiple modalities, which is used to train the multimodal large model to be trained.

The servers 101, 102, 103 may be servers providing various services, such as background management servers that provide training support for large models loaded on the servers 101, 102, 103 (for example only). The servers 101, 102, 103 acquire the training dataset from the database 105 through the network 104, train the large model to be trained, and obtain a target multimodal large model. The servers 101, 102, 103 may further invoke the target multimodal large model to perform task processing (e.g., audio segmentation, image recognition, audio recognition, visual question answering, etc.) on data to be processed (e.g., text, images, audio, videos, etc.), and send processing results to a display screen of a terminal device for display.

It should be noted that the distributed training method for a multimodal large model and the task processing method provided by embodiments of the present disclosure may be performed by the servers 101, 102, 103. Accordingly, the distributed training apparatus for a multimodal large model and the task processing apparatus provided by embodiments of the present disclosure may be disposed in the servers 101, 102, 103. The distributed training method for a multimodal large model and the task processing method provided by embodiments of the present disclosure may also be performed by the database 105. Accordingly, the distributed training apparatus for a multimodal large model and the task processing apparatus provided by embodiments of the present disclosure may be disposed in the database 105. The distributed training method for a multimodal large model and the task processing method provided by embodiments of the present disclosure may also be performed by a server or server cluster different from the servers 101, 102, 103 and capable of communicating with the servers 101, 102, 103 and/or the database 105. Accordingly, the distributed training apparatus for a multimodal large model and the task processing apparatus provided by embodiments of the present disclosure may also be disposed in a server or server cluster different from the servers 101, 102, 103 and capable of communicating with the servers 101, 102, 103 and/or the database 105.

It may be understood that the numbers and types of the servers, network, and database in FIG. 1 are merely illustrative. According to implementation needs, any number of servers, networks, and databases may be provided.

It should be understood that the system architecture of the present disclosure has been described above, and the method of the present disclosure will be described below. It should also be understood that the serial numbers of the operations in the following method are merely used to represent the operations for description, and should not be construed as indicating the execution order of the operations. Unless explicitly stated, the method does not need to be performed exactly in the order shown.

In the technical solutions of the present disclosure, the information and data involved (including but not limited to data for analysis, stored data, displayed data, etc.) are all authorized information and data, and the collection, storage, use, processing, transmission, provision, disclosure, application, and other processing of the relevant data comply with relevant laws, regulations, and standards, necessary confidentiality measures are taken, public order and good customs are not violated, and corresponding operation interfaces are provided for selecting authorization or refusal.

FIG. 2 shows a flowchart of a distributed training method for a multimodal large model according to an embodiment of the present disclosure.

As shown in FIG. 2, a method 200 may include operation S210 to operation S220.

In operation S210, by using a plurality of devices loaded with a large model to be trained, token sequences of sample data of a plurality of training data subsets respectively input into the plurality of devices are partitioned to obtain a plurality of token subsequences of the sample data for each of the plurality of training data subsets.

According to embodiments of the present disclosure, the devices may be hardware resources configured to provide training for the model to be trained, such as GPUs, TPUs, CPUs, or the like. Each device may independently perform computational tasks, such as forward propagation, backward propagation, parameter update, and the like. The devices may form a computing portion of a distributed training system. Loading the large model to be trained onto the plurality of devices may involve fully replicating parameters, computational graphs, dependencies, and the like of the large model to be trained onto the plurality of devices, such that the large model to be trained may be trained based on data parallelism (DP). The plurality of devices may establish a communication mechanism for mutual communication, so as to transmit data with each other.

According to embodiments of the present disclosure, a token sequence may include a plurality of tokens arranged in order. In a multimodal large model, a token may be a basic unit for the multimodal large model to process data of different modalities. For example, for text data, a token may be a minimum discretized representation of natural language text by a language model, including a word, a subword, a character, or the like. For another example, for image data, a token may be a discretized representation of an image by a vision model, including an image patch or a local feature. For another example, for audio data, a token may be a discretized representation of an audio signal by a language model, including a spectral feature, a phoneme, or the like. Since correlations may exist between a plurality of words, between a plurality of image patches, or between a plurality of spectral features, the corresponding plurality of tokens are sequential.

According to embodiments of the present disclosure, a difference between total numbers of tokens of the sample data contained in different training data subsets may be less than a predetermined threshold. This indicates that the sum of token numbers contained in all sample data in each training data subset does not differ significantly, such that sample sets having approximate token numbers may be equally distributed to computing units (ranks) of the devices.

According to embodiments of the present disclosure, the length of a token sequence is variable. On the basis of data parallelism, the token sequence may be further partitioned to obtain a plurality of token subsequences, and then the plurality of token subsequences may be allocated to different devices to perform sequence parallelism (SP) training on the model to be trained, thereby achieving a finer-grained load balancing strategy. A token subsequence may include at least one token.

In operation S220, the large model to be trained loaded on the plurality of devices is trained based on the plurality of token subsequences of the sample data contained in each of the plurality of training data subsets, to obtain a target multimodal large model.

According to embodiments of the present disclosure, each device may be input with one training data subset, that is, the training dataset is partitioned into a plurality of training data subsets and distributed to the devices, and the large model to be trained is trained based on a DP strategy. During the training process, each device may independently compute gradients and subsequently synchronize the gradients. Each device may perform a reduction operation (such as summation, averaging, taking a maximum value, etc.) on the gradients computed by itself with the gradients computed by other devices to generate a global result. The reduced global result is sent to all devices to ensure that each device holds the same gradients, thereby achieving gradient synchronization.

According to embodiments of the present disclosure, when training the large model to be trained based on the DP strategy, an SP strategy is further executed for training. The plurality of token subsequences obtained by partitioning the training data subset may be allocated to different devices for processing. Each device may synchronize processing results (e.g., gradients) of the corresponding token subsequence to other devices to ensure consistency of the model training.

Through the distributed training method in embodiments of the present disclosure, a hierarchical balancing strategy from coarse granularity to fine granularity is adopted. At a coarse-grained level, since the difference between total numbers of tokens of the sample data contained in different training data subsets is less than a predetermined threshold, the total amount of sample data obtained by each device is approximately balanced in the token dimension, which may significantly improve the computational load balance in the initial stage. Furthermore, at a fine-grained level, partitioning the input in the sequence dimension provides a more direct parallelization means for processing variable-length sequences, which may effectively reduce memory usage and provide a more flexible data layout for subsequent attention operations. Moreover, the combination of coarse-grained and fine-grained parallel strategies may adapt to effective balancing of the computational differences between the ViT Tokenizer and the MoE backbone network. Overall, the distributed training method may achieve effective balancing of data heterogeneity, variable input lengths, and computational differences between the ViT Tokenizer and the MoE backbone network in the distributed training of multimodal large models, thereby improving resource utilization, reducing communication overhead, and enhancing training efficiency.

In embodiments of the present disclosure, training the large model to be trained loaded on the plurality of devices may include: training functional layers of the large model to be trained loaded on the plurality of devices.

According to embodiments of the present disclosure, different devices are configured to train different functional layers of the large model to be trained. The functional layers may be modules or layers of the large model to be trained for implementing different functions, such as a text encoding module, an image encoding module, a cross-modal fusion layer, and so on. These modules or layers correspond to their respective model parameters, such that the parameter scale of the large model may reach hundreds of billions or even trillions, and it is difficult for a single device to accommodate the complete large model. Moreover, multimodal tasks (such as video understanding and long-document summarization) require processing ultra-long sequences (for example, thousands of frames in a one-minute video), and it is difficult for a single device to cache the complete sequence.

In view of the above, on the basis of the aforementioned hierarchical balancing strategy from coarse granularity to fine granularity, a pipeline parallelism (PP) strategy may be further adopted. The functional layers of the large model to be trained may be divided into a plurality of stages, for example, stage one for text encoding, stage two for image encoding, and stage three for cross-modal fusion. Each stage is allocated to a group of devices for processing, and each group of devices includes at least one device. The plurality of token subsequences may be divided into a plurality of micro-batches, and each micro-batch sequentially enters different stages. Different devices may train different functional layers of the large model to be trained in a pipeline manner, and finally, complete model training is achieved through communication between the devices.

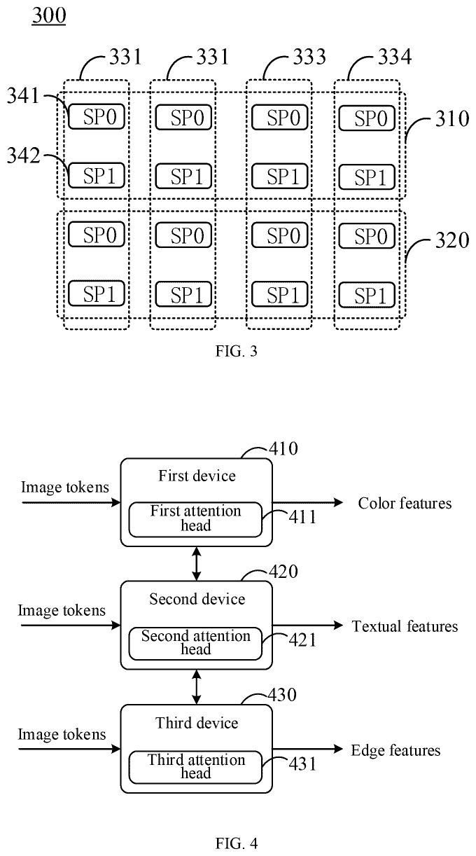

FIG. 3 shows a schematic diagram of a distributed parallel training strategy arrangement according to an embodiment of the present disclosure.

As shown in FIG. 3, for example, a parallel training strategy arrangement 300 includes 16 devices (e.g., GPUs), which may be arranged into a first DP group 310 and a second DP group 320. Each DP group may include a first PP group 331, a second PP group 332, a third PP group 333, and a fourth PP group 334. Each PP group may include a first SP group 341 and a second SP group 342. Such an arrangement allows the PP groups within each DP group to independently read sample data. The combination of such multi-dimensional parallel strategies is intended to address the complexity of large-scale model training and provide a foundation for subsequent fine-grained balancing.

According to embodiments of the present disclosure, in view that the ViT Tokenizer typically has a small parameter scale, a complete instance of the ViT Tokenizer may be deployed on a computing unit (rank) of each parallel dimension (DP, PP, SP) in order to achieve the integration of DP, PP, and SP parallel dimensions. The mutual combination of DP, PP, and SP may avoid duplicate communication and computation of the ViT Tokenizer across different parallel dimensions.

Through the distributed training method in embodiments of the present disclosure, a coarse-grained balancing strategy of pipeline parallelism is integrated on the basis of the hierarchical balancing strategy from coarse granularity to fine granularity. This may further break through the memory limitations of a single device and avoid the problem that devices may be idle (for example, “bubbles”) due to waiting for gradient synchronization or data loading. Furthermore, pipeline parallelism may allocate different stages according to device characteristics (for example, allocating computation-intensive stages to GPUs and I/O-intensive stages to CPUs), which may adapt to data heterogeneity, thereby improving resource utilization, reducing communication overhead, and enhancing training efficiency.

In embodiments of the present disclosure, the functional layers may include a multi-attention operation layer, and the multi-attention operation layer may be configured to perform multi-attention operations. Based on this, the distributed training method may further include: loading a plurality of attention heads of the multi-attention operation layer onto the plurality of devices, where each device is loaded with a portion of the attention heads, and different devices are loaded with different portions of the attention heads.

According to embodiments of the present disclosure, the attention heads may focus on different features of data. By fusing the results of separate operations of the plurality of attention heads, a richer representation of data may be obtained. Therefore, the plurality of attention heads may be distributed and loaded onto different devices to achieve parallel computation of the plurality of attention heads.

FIG. 4 shows a layout diagram of a plurality of attention heads according to an embodiment of the present disclosure.

Taking sample data as an image for illustration, as shown in FIG. 4, a layout 400 of a plurality of attention heads may be as follows. A first device 410 may be loaded with a first attention head 411 to perform an attention operation on tokens of the image to obtain color features of the image. A second device 420 may be loaded with a second attention head 421 to perform an attention operation on the image to obtain texture features of the image. A third device 430 may be loaded with a third attention head 431 to perform an attention operation on the image to obtain edge features of the image. Finally, the first device 410, the second device 420, and the third device 430 may communicate with each other to fuse the color features, the texture features, and the edge features of the image to obtain fused features of the image. In this way, each device only needs to independently perform computation for a portion of the attention heads to obtain complete features.

Through the distributed training method in embodiments of the present disclosure, the plurality of attention heads for the attention operations are divided in the head dimension and deployed on different devices. Since the attention operations may be performed independently, each device only stores parameters and intermediate results of a portion of the heads, which may further reduce memory usage and communication overhead while maintaining computational efficiency and scalability.

In embodiments of the present disclosure, the sample data may be allocated at a coarse-grained level (DP and PP) before being input into the devices. The distributed training method may further include: processing each sample data in a training dataset to obtain a token sequence of each sample data; and partitioning the training dataset into a plurality of training data subsets based on the token sequence of each sample data.

According to embodiments of the present disclosure, due to the heterogeneity existing between the sample data in the acquired training dataset, in order to enable load balancing across a plurality of distributed devices, the sample data may be pre-allocated in a balanced manner based on the tokens of the sample data, such that each device has sample data with an approximate number of tokens.

Through the distributed training method in embodiments of the present disclosure, the training dataset is allocated based on the processed tokens of each sample data, which may ensure that, at the coarse-grained level of DP and PP, the total amount of sample data obtained by each device is approximately balanced in the token dimension, thereby significantly improving the computational load balance in the initial stage.

In embodiments of the present disclosure, processing each sample data in the training dataset to obtain the token sequence of each sample data may include: partitioning the sample data into a plurality of data blocks based on a data volume of the sample data; and separately encoding each data block and adding a position information of each data block to obtain tokens of the plurality of data blocks, where the tokens of the plurality of data blocks constitute the token sequence of the sample data.

Exemplarily, when the sample data is text, the text may be partitioned into a plurality of words or phrases based on a length of the text, and each word or phrase serves as a data block. Text encoding is then performed on each word or phrase. Position information may be added to the encoded words or phrases based on a sequential order of the words or phrases in the text, thereby obtaining text tokens corresponding to the words or phrases.

When the sample data is an image, the image may be partitioned into a plurality of image patches. Each image patch is encoded, and a position information is added to the encoded image patch based on a position of the image patch in the entire image to obtain an image token corresponding to the image patch. The image may be processed based on the ViT Tokenizer to generate the number of patched tokens.

When the sample data is audio data, the original audio may be converted into time-frequency domain features (such as a Mel spectrogram). The time-frequency domain features may be classified into multiple categories by clustering, and each category of time-frequency domain features may be mapped based on time sequence to obtain audio tokens for each category of time-frequency domain features.

Through the distributed training method in embodiments of the present disclosure, by first partitioning into blocks, then encoding, and then adding position information, a token sequence that retains both local and global information may be obtained, thereby ensuring model training accuracy.

In embodiments of the present disclosure, partitioning the training dataset into a plurality of training data subsets based on the token sequence of each sample data includes: sorting the numbers of tokens contained in all sample data; grouping the training dataset based on a predetermined number threshold and the sorted numbers of tokens to obtain a plurality of candidate training dataset groups; equally dividing each candidate training dataset group into a plurality of candidate data subsets, and selecting one of the plurality of candidate data subsets from each candidate training dataset group as a selected data subset; and combining a plurality of selected data subsets to form the training data subset.

According to embodiments of the present disclosure, the predetermined number threshold may be determined based on the scale of the large model to be trained and the number of DP groups.

FIG. 5 shows a schematic diagram of determining training data subsets based on tokens according to an embodiment of the present disclosure.

As shown in FIG. 5, a parallel training strategy arrangement 500 includes 16 devices (e.g., GPUs). If the strategy of determining training data subsets based on tokens according to embodiments of the present disclosure is adopted to directly allocate sample data, the total numbers of tokens (for example, a length of a vertical bar represents the number of tokens, and the longer the vertical bar, the greater the number of tokens of the sample data) of the sample data (for example, each vertical bar represents one sample data, and vertical bars with different filling patterns represent different sample data) respectively corresponding to a first PP group 531, a second PP group 532, a third PP group 533, and a fourth PP group 534 in a first DP group 510, and a first PP group 531, a second PP group 532, a third PP group 533, and a fourth PP group 534 in a second DP group 520 (partially replaced by ellipses and not shown in the figure) vary significantly (as shown in the first row in FIG. 5).

The numbers of tokens of the sample data may be sorted in ascending order to obtain a sorting result 550 (as shown in the second row in FIG. 5). The training dataset is then grouped based on the predetermined number threshold and the sorted numbers of tokens to obtain, for example, four candidate training dataset groups. For each candidate training dataset group, the sample data is equally allocated to the first PP group 531, the second PP group 532, the third PP group 533, and the fourth PP group 534 in the first DP group 510, and the first PP group 531, the second PP group 532, the third PP group 533, and the fourth PP group 534 in the second DP group 520. After such allocation, the total numbers of tokens in the first PP group 531, the second PP group 532, the third PP group 533, and the fourth PP group 534 in the first DP group 510, and the first PP group 531, the second PP group 532, the third PP group 533, and the fourth PP group 534 in the second DP group 520 are approximately equal (as shown in the third row in FIG. 5).

It should be noted that the allocation of sample data is intended to achieve coarse-grained (DP and PP) balancing, which may ensure that the total number of tokens processed is approximately equal across DP groups and PP groups.

Through the distributed training method in embodiments of the present disclosure, sample sets having approximate numbers of tokens are sorted and then equally allocated to computing units of the DP groups and PP groups. This may further ensure that the total amount of samples obtained by the computing units of each DP group and PP group is approximately balanced in the token dimension, which lays a foundation for subsequent fine-grained (SP) balancing and avoids severe load imbalance in the early stages.

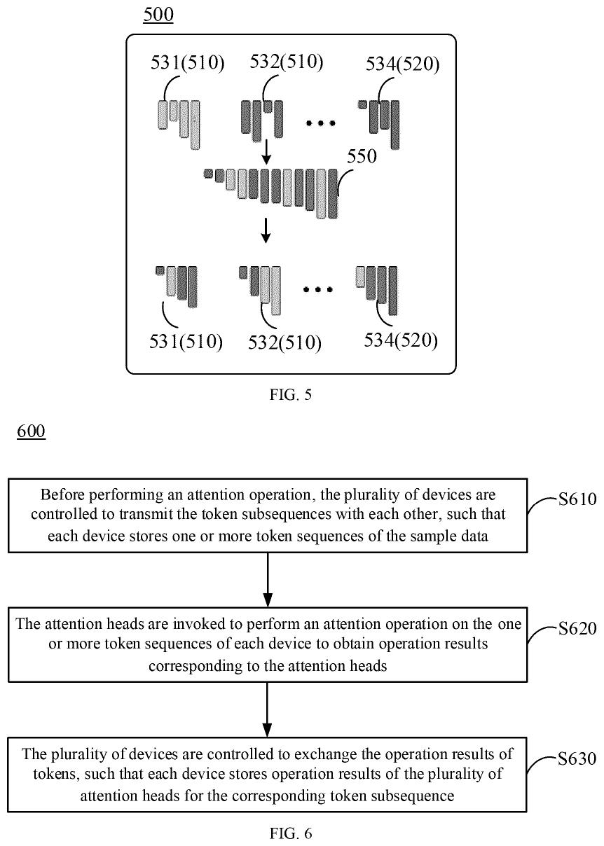

FIG. 6 shows a flowchart of a distributed training method for a multimodal large model according to another embodiment of the present disclosure.

As shown in FIG. 6, a method 600 may include operation S610 to operation S630.

In operation S610, before performing an attention operation, the plurality of devices are controlled to transmit the token subsequences with each other, such that each device stores one or more token sequence of the sample data.

According to embodiments of the present disclosure, in the attention operation stage of the large model, in order to aggregate the complete token sequence to perform an attention operation, the token subsequences received by the plurality of devices may be exchanged to obtain complete token sequences.

In operation S620, the attention heads are invoked to perform an attention operation on the one or more token sequences of each device to obtain operation results corresponding to the attention heads.

According to embodiments of the present disclosure, a portion of the attention heads loaded on the devices may perform an attention operation on complete token sequences obtained after the exchange.

In operation S630, the plurality of devices are controlled to exchange the operation results of tokens, such that each device stores operation results of the plurality of attention heads for the corresponding token subsequence.

According to embodiments of the present disclosure, although the sample data is partitioned in the sequence dimension and the plurality of attention heads are divided in the head dimension, partition switching between the sequence dimension and the head dimension may be performed through communication between the devices before the attention operation is performed. Although the sample data is partitioned in the sequence dimension, it may be ensured that each attention head may access a complete token sequence through communication during the attention operation.

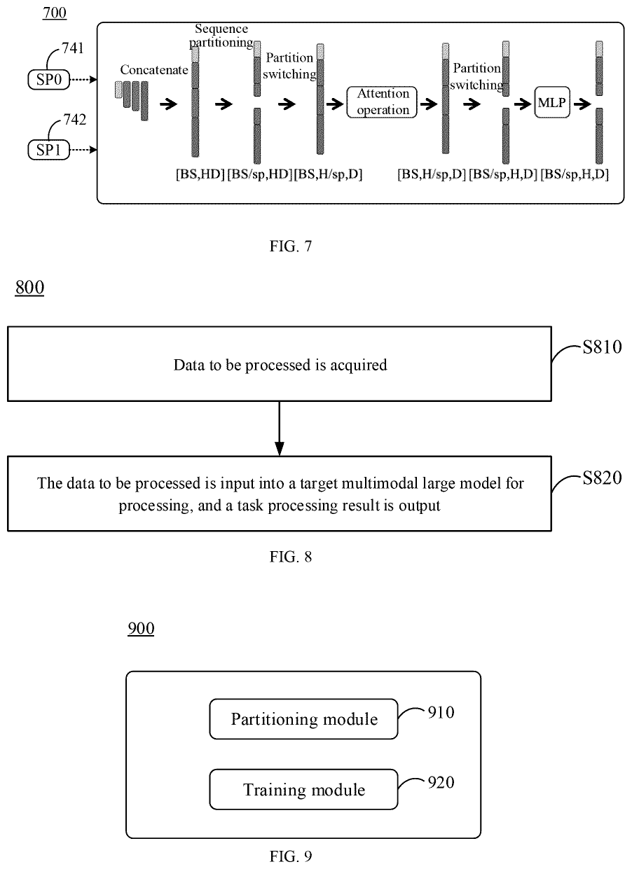

FIG. 7 shows a schematic diagram of partition switching between the sequence dimension and the head dimension according to an embodiment of the present disclosure.

As shown in FIG. 7, for example, a parallel training strategy arrangement 700 includes 16 devices (e.g., GPUs). For the first SP group 741 and the second SP group 742, the principle of partition switching between the sequence dimension and the head dimension is the same.

In the first SP group 741 or the second SP group 742, a plurality of tokens of the sample data in the training data subset are concatenated to obtain a token sequence. A tensor size of the token sequence may be represented as [BS, H, D], where B represents the batch size, S represents the number of tokens per sample data (for example, the number of tokens per image or video sequence), H represents the number of heads for the attention operation, and D represents the feature dimension of each attention head. Since the number of tokens of each sample data may vary, BS is a representation after combining the batch size and the sequence dimension.

After sequence partitioning and even allocation, the tensor size of the data allocated to each SP is [BS/sp, H, D] (where sp represents the size of the SP group, e.g., 2). This step ensures that memory allocation is completely balanced, reflecting the advantage of data balancing for memory balancing.

Dimension partition switching is performed before the attention operation. After the partition switching, the tensor size of the data allocated to each SP becomes [BS, H/sp, D]. At this point, the memory usage remains fully balanced, and it may be ensured that the computation across SP ranks is balanced, reflecting the computational balancing advantage of the balancing strategy.

Dimension restoration after the attention operation: upon completion of the attention operation, communication between the devices is required to perform partition switching between the sequence dimension and the head dimension, restoring the tensor size of the data in each SP group to [BS/sp, H, D]. This enables subsequent matrix computations and multi-layer perceptron (MLP) computations of the data.

For example, assume a token sequence of length 100 (tokens 0 to 99), and 4 GPUs (GPU 0 to 3) are used for token sequence parallelism. When partitioning in the sequence dimension, each GPU may be responsible for processing 25 tokens of the sequence, which may be expressed as:
GPU 0: tokens 0 to 24.
GPU 1: tokens 25 to 49.
GPU 2: tokens 50 to 74.
GPU 3: tokens 75 to 99.

Assume the model has 8 attention heads (attention heads 0 to 7), and 4 GPUs are used for parallel computation. When partitioning in the head dimension, each GPU may be responsible for processing 2 attention heads.

Partitioning in the sequence dimension: each GPU holds a portion of the token sequence (for example, GPU 0 holds tokens 0-24, GPU 1 holds tokens 25-49, and so on).

Through communication between the devices, the sequence fragments and the attention heads are exchanged such that each GPU holds certain attention heads for the complete sequence. The result of the exchange may be expressed as:
GPU 0 holds attention heads 0 and 1 for tokens 0 to 99.
GPU 1 holds attention heads 2 and 3 for tokens 0 to 99.
GPU 2 holds attention heads 4 and 5 for tokens 0 to 99.
GPU 3 holds attention heads 6 and 7 for tokens 0 to 99.

Through communication between the devices, the attention heads and the sequence fragments are exchanged such that each GPU holds a portion of the token sequence for all the attention heads. The result of the exchange may be expressed as:
GPU 0 holds operation results of attention heads 0 to 7 for tokens 0 to 24.
GPU 1 holds operation results of attention heads 0 to 7 for tokens 25 to 49.
GPU 2 holds operation results of attention heads 0 to 7 for tokens 50 to 74.
GPU 3 holds operation results of attention heads 0 to 7 for tokens 75 to 99.

Through the distributed training method in embodiments of the present disclosure, when partitioning in the sequence dimension, each device only needs to store a portion of the tokens, thereby reducing memory usage. When partitioning in the head dimension, each device only needs to store the operation results for a portion of the attention heads, thereby further reducing memory usage. On this basis, through dynamic partition switching between the sequence dimension and the head dimension, it may be ensured that the computational load across the devices is balanced, avoiding overload on some devices. Through fine-grained parallelization and dynamic partitioning, the performance and robustness of large-model distributed training in complex heterogeneous environments are significantly improved.

In embodiments of the present disclosure, partitioning the token sequences of the sample data of the plurality of training data subsets respectively input into the plurality of devices includes: partitioning a token sequence of the sample data in a training data subset input into a device based on at least one of storage resources of the device, computational resources of the device, and a length of the token sequence, to obtain the token subsequences.

According to embodiments of the present disclosure, during the actual training process, as training progresses, the available storage resources and computational resources of different devices may vary, and the length of the token sequence being processed may also differ. Therefore, the token sequence may be dynamically partitioned according to storage resources of the device, computational resources of the device, and the length of the token sequence.

Through the distributed training method in embodiments of the present disclosure, dynamically partitioning the token sequence based on storage resources of the device, computational resources of the device, and the length of the token sequence may dynamically balance memory usage and computational load, thereby improving training efficiency, scalability, and resource utilization.

In embodiments of the present disclosure, partitioning the token sequences of the sample data of the plurality of training data subsets respectively input into the plurality of devices further includes: partitioning the token sequences of the sample data based on a visibility constraint condition to obtain the token subsequences.

According to embodiments of the present disclosure, the visibility constraint condition may include: when performing an attention operation, tokens in the token sequence of the same sample data are accessible, and tokens in token sequences of different sample data are not simultaneously accessible.

For example, for images or videos, intra-frame tokens are visible, meaning that tokens (such as patches or tokenized pixels) within the same frame (image or video frame) must be mutually visible, that is, the model is allowed to access all tokens within the same frame during the attention operation. Inter-frame tokens are not visible, meaning that tokens across different frames are not visible by default, that is, the model is not allowed to directly access tokens from other frames during the attention operation. Therefore, when partitioning the token sequence, it is necessary to ensure that the subsequent attention operation strictly follows the constraint that tokens across different image or video frames are not mutually visible, while tokens within the same frame remain visible.

For example, assume a video sequence containing 3 frames, where each frame is partitioned into 4 patches (tokens), resulting in a total of 12 tokens. The partitioning method for distributed training is as follows:

Implementation of intra-frame visibility: the 4 tokens of each frame are allocated to the same device, which may be expressed as:
GPU 0: 4 tokens of frame 1.
GPU 1: 4 tokens of frame 2.
GPU 2: 4 tokens of frame 3.

Attention operation: on GPU0, the tokens of frame 1 may attend to each other, but do not access tokens on GPU1 or GPU2.

Implementation of inter-frame invisibility: in an attention weight matrix for the tokens of frame 1, the weights corresponding to the tokens of frame 2 and frame 3 are set to 0. Similarly, the tokens of frame 2 and frame 3 do not attend to tokens of other frames.

Through the distributed training method in embodiments of the present disclosure, sequence partitioning is performed using visibility constraints, which may ensure that tokens within the same frame are not divided into different batches, thereby enabling the large model to capture both local and global semantic information within a frame (for example, an object relationship in an image and a spatial structure in a video frame). Further, global attention operations across frames is avoided, thereby reducing memory usage and computational overhead. This also ensures that, when processing a single frame, the model is not interfered by other frames (for example, different frames in a video may correspond to different scenes or actions), thereby maintaining semantic independence and effectively balancing computational efficiency and semantic integrity.

It should be noted that the communication between devices in embodiments of the present disclosure may adopt an all-to-all communication mechanism, in which each device (for example, a computing unit, GPU, CPU, etc.) sends data to all other devices and simultaneously receives data from all other devices.

It should be noted that the distributed training method in embodiments of the present disclosure adopts a hierarchical balancing strategy from coarse granularity to fine granularity, which may ensure that the computational load is more balanced across different devices, thereby significantly reducing waiting time and idle resources and accelerating the training process. Through refined memory balancing strategies (such as equal partitioning within sequence parallelism and dynamic dimension switching), the method effectively addresses memory overflow issues caused by long sequences and high-resolution inputs, allowing the use of larger effective batch sizes under limited hardware resources. This not only reduces reliance on expensive high-end hardware but also maximizes the utilization of existing computing clusters, thereby lowering training costs. The hierarchical balancing strategy enables the system to better adapt to heterogeneous distributed environments and dynamically changing input data. Whether in data parallelism (DP), pipeline parallelism (PP), or sequence parallelism (SP), improved load balancing may be achieved in their respective dimensions, reducing the risk of straggler effect. This robustness ensures that even under extreme data distributions or partial hardware performance fluctuations, the training process remains stable and efficient. Meanwhile, multi-dimensional parallel optimization provides a solid foundation for scaling models to larger parameter sizes and more complex modalities. Experimental results show that, in end-to-end multimodal training, this method achieves an overall performance improvement of up to 32%. This means that products enable faster model iteration, shorter development cycles, and quicker deployment of new features to market.

It should be noted that although the training method combining DP, PP, and SP with dynamic partitioning proposed in embodiments of the present disclosure has significant advantages, there may exist alternative solutions or complementary technologies that partially or fully achieve similar objectives. These alternative solutions may provide different trade-offs in specific scenarios, such as implementation complexity, communication efficiency, or optimization for specific hardware. For example, multimodal workloads may be optimized through four components: a modality-aware partitioner, a data load balancer, a heterogeneity-aware placement manager, and a pipeline executor. The load balancer may balance the computation duration of submodules corresponding to different modalities by using dynamic programming, and reallocate batch sizes. The pipeline executor may introduce batch-synchronization instructions for scheduling, thereby addressing semantic issues and batch-size limitations of PP in multimodal contrastive learning. Although such load balancer shares similar goals with the distributed training method of the present disclosure in handling multimodal heterogeneity and batch size requirements, its focus may be on macro-level coordination across submodules corresponding to different modalities rather than dynamic dimension switching within sequence parallelism.

It should be noted that to address the high communication overhead of cross-attention layers in multimodal large models, a distributed and precise cross-attention mechanism may be employed. It is observed that query blocks are typically much smaller than key-value blocks, such that smaller query blocks may be exchanged across devices while larger key-value blocks are retained locally. Although this approach primarily focuses on cross-attention rather than sequence parallelism in self-attention, its communication optimization and activation re-computation techniques may complement or serve as an alternative solution to certain parts of the aforementioned distributed training method to reduce communication and memory costs.

It should be noted that memory usage may be reduced and computational efficiency may be improved by optimizing the memory access patterns of the attention operation. Although such techniques do not directly address data imbalance, they may serve as foundational optimizations for the attention operation stage of the aforementioned distributed training method, or indirectly improve resource utilization by combining with more flexible parallel strategies.

It should be noted that to address the straggler problem in distributed training, a semi-dynamic load balancing method may be employed. This method performs load balancing at iteration boundaries by adjusting sample batch sizes according to the real-time processing capability of worker nodes. Although it mainly targets differences in computational performance rather than data heterogeneity, its concept of dynamically adjusting workloads is similar to the coarse-grained sample allocation in the aforementioned distributed training method and may serve as a general alternative solution for load balancing.

It should be noted that a batching algorithm that combines model architecture and hardware characteristics, such as batching by dynamic grouping based on sequence length, may further reduce padding overhead. These methods may achieve partial balancing at the data loading level, thereby alleviating the burden on backend distributed strategies.

FIG. 8 shows a flowchart of a task processing method according to an embodiment of the present disclosure.

As shown in FIG. 8, a method 800 may include operation S810 to operation S820.

In operation S810, data to be processed is acquired.

According to embodiments of the present disclosure, the data to be processed may include multimodal data consisting of text, images, audio, and videos.

In operation S820, the data to be processed is input into a target multimodal large model for processing, and a task processing result is output.

According to embodiments of the present disclosure, the target multimodal large model may be trained based on the aforementioned distributed training method. For specific implementation details, reference may be made to embodiments of the training method described above, which will not be repeated here.

The following provides a schematic description of a distributed training apparatus for a multimodal large model according to an embodiment of the present disclosure with reference to FIG. 9. FIG. 9 shows a block diagram of a distributed training apparatus for a multimodal large model according to an embodiment of the present disclosure.

As shown in FIG. 9, a distributed training apparatus 900 for a multimodal large model may include a partitioning module 910 and a training module 920.

The partitioning module 910 is configured to partition, by using a plurality of devices loaded with a large model to be trained, token sequences of sample data of a plurality of training data subsets respectively input into the plurality of devices, to obtain a plurality of token subsequences of the sample data for each of the plurality of training data subsets, where a difference between total numbers of tokens of the sample data contained in different training data subsets is less than a predetermined threshold. In an embodiment, the partitioning module 910 may be configured to perform operation S210 described above, which will not be repeated here.

The training module 920 is configured to train the large model to be trained loaded on the plurality of devices based on the plurality of token subsequences of the sample data for each of the plurality of training data subsets, to obtain a target multimodal large model, where each device is input with one training data subset. In an embodiment, the training module 920 may be configured to perform operation S220 described above, which will not be repeated here.

It should be noted that other implementation details and technical effects of the distributed training apparatus for a multimodal large model are the same as or similar to those of the distributed training method for a multimodal large model, and will not be repeated here.

According to embodiments of the present disclosure, the training module 920 training the large model to be trained loaded on the plurality of devices may include: training functional layers of the large model to be trained loaded on the plurality of devices, where different devices are configured to train different functional layers of the large model to be trained.

According to embodiments of the present disclosure, the functional layers include a multi-attention operation layer, and the distributed training apparatus 900 for a multimodal large model may further include: a loading module 930 configured to load a plurality of attention heads of the multi-attention operation layer onto the plurality of devices, where each device is loaded with a portion of the attention heads, and different devices are loaded with different portions of the attention heads.

According to embodiments of the present disclosure, the distributed training apparatus 900 for a multimodal large model may further include: a first transmission module 940 configured to, before performing an attention operation, control the plurality of devices to transmit the token subsequences with each other, such that each device stores one or more token sequences of the sample data; an invocation module 950 configured to invoke the attention heads to perform the attention operation on the one or more token sequences of each device to obtain operation results corresponding to the attention heads; and a second transmission module 960 configured to control the plurality of devices to exchange operation results of tokens, such that each device stores operation results of the plurality of attention heads for the corresponding token subsequence.

According to embodiments of the present disclosure, the distributed training apparatus 900 for a multimodal large model may further include: a processing module 970 configured to process each sample data in a training dataset to obtain a token sequence for each sample data; and a dividing module 980 configured to divide the training dataset into a plurality of training data subsets based on the token sequences of the sample data.

According to embodiments of the present disclosure, the processing module 970 processing each sample data in the training dataset to obtain a token sequence for each sample data may include: partitioning the sample data into a plurality of data blocks based on a data volume of the sample data; and encoding each data block and adding a position information of each data block to obtain tokens of the plurality of data blocks, where the tokens of the data blocks constitute the token sequence of the sample data.

According to embodiments of the present disclosure, the dividing module 980 dividing the training dataset into a plurality of training data subsets based on the token sequences of the sample data may include: sorting the numbers of tokens contained in all sample data; grouping the training dataset based on a predetermined number threshold and the sorted numbers of tokens to obtain a plurality of candidate training dataset groups; equally dividing each candidate training dataset group into a plurality of candidate data subsets, selecting one of the plurality of candidate data subsets from each candidate training dataset group as a selected data subset; and combining a plurality of selected data subsets to form the training data subset.

According to embodiments of the present disclosure, the partitioning module 910 partitioning the token sequences of the sample data of the plurality of training data subsets respectively input into the plurality of devices may include: partitioning a token sequence of the sample data in a training data subset input into a device based on at least one of storage resources of the device, computational resources of the device, and a length of the token sequence, to obtain the token subsequences.

According to embodiments of the present disclosure, the partitioning module 910 partitioning the token sequences of the sample data of the plurality of training data subsets respectively input into the plurality of devices may further include: partitioning the token sequences of the sample data based on a visibility constraint condition to obtain the token subsequences, where the visibility constraint condition specifies that, during execution of an attention operation, tokens in a token sequence of the same sample data are accessible, and tokens in token sequences of different sample data are not simultaneously accessible.

It should be noted that other implementation details and technical effects of the distributed training apparatus for a multimodal large model are the same as or similar to those of the distributed training method for a multimodal large model, and will not be repeated here.

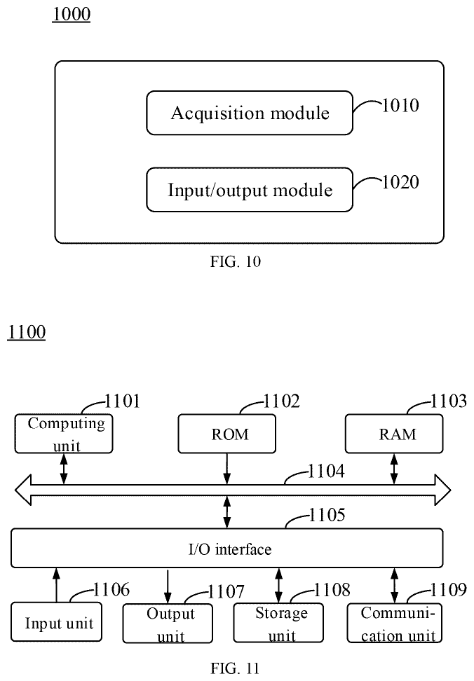

The following provides a schematic description of a task processing apparatus according to an embodiment of the present disclosure with reference to FIG. 10. FIG. 10 shows a block diagram of a task processing apparatus according to an embodiment of the present disclosure.

As shown in FIG. 10, a task processing apparatus 1000 may include an acquisition module 1010 and an input/output module 1020.

The acquisition module 1010 is configured to acquire data to be processed. In an embodiment, the acquisition module 1010 may be configured to perform operation S810 described above, which will not be repeated here.

The input/output module 1020 is configured to input the data to be processed into a target multimodal large model for processing, to output a task processing result, where each device is input with one training data subset. The target multimodal large model is trained based on the training method or training apparatus of the present disclosure. In an embodiment, the input/output module 1020 may be configured to perform operation S820 described above, which will not be repeated here.

It should be noted that other implementation details and technical effects of the task processing apparatus are the same as or similar to those of the task processing method, and will not be repeated here.

According to embodiments of the present disclosure, the present disclosure further provides an electronic device, a readable storage medium, and a computer program product.

FIG. 11 shows a schematic block diagram of an exemplary electronic device 1100 that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the electronic device 1100 includes a computing unit 1101 which may perform various appropriate actions and processes according to a computer program stored in a read-only memory (ROM) 1102 or a computer program loaded from a storage unit 1108 into a random access memory (RAM) 1103. In the RAM 1103, various programs and data necessary for an operation of the electronic device 1100 may also be stored. The computing unit 1101, the ROM 1102 and the RAM 1103 are connected to each other through a bus 1104. An input/output (I/O) interface 1105 is also connected to the bus 1104.

A plurality of components in the electronic device 1100 are connected to the input/output (I/O) interface 1105, including: an input unit 1106, such as a keyboard, or a mouse; an output unit 1107, such as displays or speakers of various types; a storage unit 1108, such as a disk, or an optical disc; and a communication unit 1109, such as a network card, a modem, or a wireless communication transceiver. The communication unit 1109 allows the electronic device 1100 to exchange information/data with other devices through a computer network such as Internet and/or various telecommunication networks.

The computing unit 1101 may be various general-purpose and/or dedicated processing assemblies having processing and computing capabilities. Some examples of the computing units 1101 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 1101 executes various methods and processes described above, such as the distributed training method for a multimodal large model and/or the task processing method. For example, in some embodiments, the distributed training method for a multimodal large model and/or the task processing method may be implemented as a computer software program which is tangibly embodied in a machine-readable medium, such as the storage unit 1108. In some embodiments, the computer program may be partially or entirely loaded and/or installed in the electronic device 1100 via the ROM 1102 and/or the communication unit 1109. The computer program, when loaded in the RAM 1103 and executed by the computing unit 1101, may execute one or more steps in the distributed training method for a multimodal large model and/or the task processing method described above. Alternatively, in other embodiments, the computing unit 1101 may be used to perform the distributed training method for a multimodal large model and/or the task processing method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable information processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory, a read only memory, an erasable programmable read-only memory (EPROM) or a flash memory, an optical fiber, a compact disk read-only memory (CD-ROM), an optical storage device, a magnetic storage device, or any suitable combination of the above.

In order to provide interaction with the user, the systems and technologies described here may be implemented on a computer including a display device (for example, a cathode ray tube (CRT) or liquid crystal display (LCD)) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A distributed training method for a multimodal large model, comprising:
partitioning, by using a plurality of devices loaded with a large model to be trained, token sequences of sample data of a plurality of training data subsets respectively input into the plurality of devices, to obtain a plurality of token subsequences of the sample data for each of the plurality of training data subsets, wherein a difference between total numbers of tokens of the sample data contained in different training data subsets is less than a predetermined threshold; and
training the large model to be trained loaded on the plurality of devices based on the plurality of token subsequences of the sample data for each of the plurality of training data subsets, to obtain a target multimodal large model, wherein each device is input with one training data subset.

2. The method of claim 1, wherein the training the large model to be trained loaded on the plurality of devices comprises:
training functional layers of the large model to be trained loaded on the plurality of devices, wherein different devices are configured to train different functional layers of the large model to be trained.

3. The method of claim 2, wherein the functional layers comprise a multi-attention operation layer, and the method further comprises:
loading a plurality of attention heads of the multi-attention operation layer onto the plurality of devices, wherein each device is loaded with a portion of the plurality of attention heads, and different devices are loaded with different portions of the plurality of attention heads.

4. The method of claim 3, further comprising:
before performing an attention operation, controlling the plurality of devices to transmit the plurality of token subsequences with each other, such that each device stores one or more token sequences of the sample data;
invoking the plurality of attention heads to perform the attention operation on the one or more token sequences of each device to obtain operation results corresponding to the plurality of attention heads; and
controlling the plurality of devices to exchange the operation results of tokens such that each device stores operation results of the plurality of attention heads for a corresponding token subsequence.

5. The method of claim 1, further comprising:
processing each sample data in a training dataset to obtain a token sequence of each sample data; and
dividing the training dataset into the plurality of training data subsets based on the token sequence of each sample data.

6. The method of claim 5, wherein the processing each sample data in a training dataset to obtain a token sequence of each sample data comprises:
partitioning the sample data into a plurality of data blocks based on a data volume of the sample data; and
encoding each data block and adding a position information of each data block to obtain tokens of the plurality of data blocks, wherein the tokens of the plurality of data blocks constitute the token sequence of the sample data.

7. The method of claim 5, wherein the dividing the training dataset into the plurality of training data subsets based on the token sequence of each sample data comprises:
sorting numbers of tokens contained in all sample data;
grouping the training dataset based on a predetermined number threshold and the sorted numbers of tokens to obtain a plurality of candidate training dataset groups; and
equally dividing each candidate training dataset group into a plurality of candidate data subsets, and selecting one of the plurality of candidate data subsets from each candidate training dataset group as a selected data subset; and
combining a plurality of selected data subsets to form the training data subset.

8. The method of claim 1, wherein the partitioning token sequences of sample data of a plurality of training data subsets respectively input into the plurality of devices comprises:
partitioning a token sequence of the sample data in a training data subset input into a device based on at least one of storage resources of the device, computational resources of the device, and a length of the token sequence, to obtain the plurality of token subsequences.

9. The method of claim 1, wherein the partitioning token sequences of sample data of a plurality of training data subsets respectively input into the plurality of devices further comprises:
partitioning the token sequences of the sample data based on a visibility constraint condition to obtain the plurality of token subsequences, wherein the visibility constraint condition specifies that during execution of an attention operation, tokens in a token sequence of the same sample data are accessible, and tokens in token sequences of different sample data are not simultaneously accessible.

10. A task processing method, comprising:
inputting data to be processed into a target multimodal large model for processing, to output a task processing result, wherein the target multimodal large model is trained based on the training method of claim 1.

11. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
partition, by using a plurality of devices loaded with a large model to be trained, token sequences of sample data of a plurality of training data subsets respectively input into the plurality of devices, to obtain a plurality of token subsequences of the sample data for each of the plurality of training data subsets, wherein a difference between total numbers of tokens of the sample data contained in different training data subsets is less than a predetermined threshold; and
train the large model to be trained loaded on the plurality of devices based on the plurality of token subsequences of the sample data for each of the plurality of training data subsets, to obtain a target multimodal large model, wherein each device is input with one training data subset.

12. The electronic device of claim 11, wherein the at least one processor is further configured to:
train functional layers of the large model to be trained loaded on the plurality of devices, wherein different devices are configured to train different functional layers of the large model to be trained.

13. The electronic device of claim 12, wherein the functional layers comprise a multi-attention operation layer, and the at least one processor is further configured to:
load a plurality of attention heads of the multi-attention operation layer onto the plurality of devices, wherein each device is loaded with a portion of the plurality of attention heads, and different devices are loaded with different portions of the plurality of attention heads.

14. The electronic device of claim 13, wherein the at least one processor is further configured to:
before performing an attention operation, control the plurality of devices to transmit the plurality of token subsequences with each other, such that each device stores one or more token sequences of the sample data;
invoke the plurality of attention heads to perform the attention operation on the one or more token sequences of each device to obtain operation results corresponding to the plurality of attention heads; and
control the plurality of devices to exchange the operation results of tokens such that each device stores operation results of the plurality of attention heads for a corresponding token subsequence.

15. The electronic device of claim 11, wherein the at least one processor is further configured to:
process each sample data in a training dataset to obtain a token sequence of each sample data; and
divide the training dataset into the plurality of training data subsets based on the token sequence of each sample data.

16. The electronic device of claim 15, wherein the at least one processor is further configured to:
partition the sample data into a plurality of data blocks based on a data volume of the sample data; and
encode each data block and add a position information of each data block to obtain tokens of the plurality of data blocks, wherein the tokens of the plurality of data blocks constitute the token sequence of the sample data.

17. The electronic device of claim 15, wherein the at least one processor is further configured to:
sort numbers of tokens contained in all sample data;
group the training dataset based on a predetermined number threshold and the sorted numbers of tokens to obtain a plurality of candidate training dataset groups; and
equally divide each candidate training dataset group into a plurality of candidate data subsets, and select one of the plurality of candidate data subsets from each candidate training dataset group as a selected data subset; and
combine a plurality of selected data subsets to form the training data subset.

18. A non-transitory computer-readable storage medium having computer instructions therein, wherein the computer instructions, when executed by at least one processor, are configured to cause a computer to:
partition, by using a plurality of devices loaded with a large model to be trained, token sequences of sample data of a plurality of training data subsets respectively input into the plurality of devices, to obtain a plurality of token subsequences of the sample data for each of the plurality of training data subsets, wherein a difference between total numbers of tokens of the sample data contained in different training data subsets is less than a predetermined threshold; and
train the large model to be trained loaded on the plurality of devices based on the plurality of token subsequences of the sample data for each of the plurality of training data subsets, to obtain a target multimodal large model, wherein each device is input with one training data subset.

19. An electronic device, comprising:
at least one processor; and
a memory communicatively connected to the at least one processor, wherein the memory stores instructions executable by the at least one processor, and the instructions are configured to, when executed by the at least one processor, cause the at least one processor to perform the method of claim 10.

20. A non-transitory computer-readable storage medium having computer instructions therein, wherein the computer instructions, when executed by at least one processor, are configured to cause a computer to perform the method of claim 10.
